(19) United States
(12) Patent Application Publication
(10) Pub. No.: US 2010/0329154 A1
(43) Pub. Date: Dec. 30, 2010

(54) Efficient calculation of routing tables for routing based on destination addresses

(76) Inventors: Joachim Charzinski, Munchen (DE); Thomas Engel, Unterbiberg (DE); Christoph Reichert, Erben (DE); Susann-Maria Viktoria Mendoza-Reichert, Berlin (DE); Johann Josef Reichert, Schwarzenfeld (DE); Eva Reichert, Wien (AT)

Correspondence Address: K&L Gates LLP, P.O. BOX 1135, CHICAGO, IL, 60690, US

(21) Appl. No.: 11/630,737

(22) PCT Filed: Jun. 28, 2005
(86) PCT No.: PCT/EP05/53017

§ 371 Date: Oct. 14, 2008

(30) Foreign Application Priority Data
Jun. 30, 2004 (DE) 10 2004 031 717.8

(51) Int. Cl. H04L 12/28

(52) U.S. Cl. 370/255

(57) ABSTRACT

There is a method and a device allowing the distributed calculation of routing tables for routing in a communication network containing nodes and links. The calculation of routes to be used is carried out in centrally. Data relating to the routes to be used are transmitted to a node which, based on said information, generates a routing table by assigning packet addresses to the routes. The central calculation of the routes results in an increased efficiency of resources while requiring less calculation effort which is particularly advantageous in the context of networks comprising multipath routing where the calculation of routing tables is very complex. A further reduction in effort can be achieved by means of the central calculation of the distribution weightings.

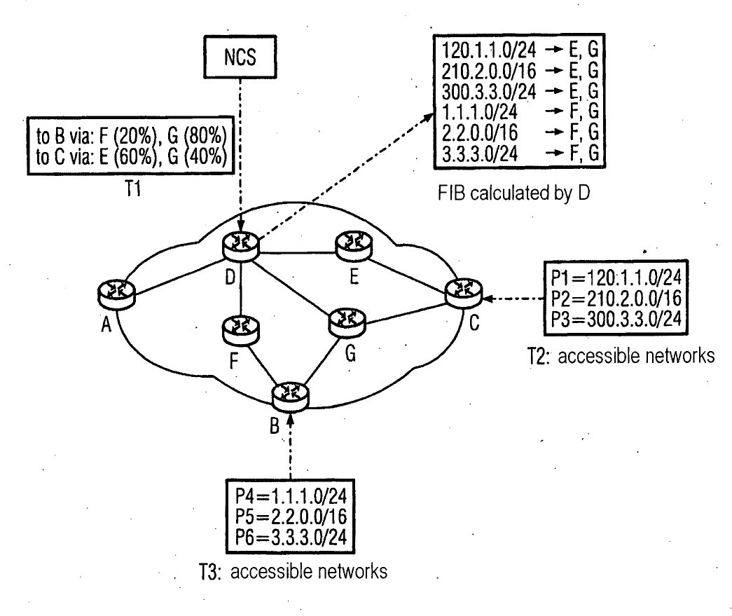

### CROSS REFERENCE TO RELATED APPLICATIONS

This application is the U.S. National Stage of International Application No. PCT/EP2005/053017, filed Jun. 28, 2005 and claims the benefit thereof. The International Application claims the benefits of German application No. 10 2004 031 717.8 DE filed Jun. 30, 2004, both of the applications are incorporated by reference herein in their entirety.

### FIELD OF INVENTION

The invention relates to a method and a device for calculating routing tables for routing within a communication network composed of nodes and links.

### BACKGROUND OF INVENTION

The transporting of traffic in data networks, particularly with regard to compliance with quality-of-service parameters, is a current area of activity for network specialists and internet experts.

The majority of present-day data networks are built on the basis of nodes or, as the case may be, routers and links or, as the case may be, edges, the traffic being transmitted packet by packet from node to node. As a rule the next node (or the “next hop”) is determined from the routing table available to the node, said routing table relating the destination addresses contained in the packets to next hops. Typically the routing tables are set up or, as the case may be, calculated using routing protocols. Examples of routing protocols of this kind are the OSPF (Open Shortest Path First) protocol, which is used in the internet in combination with the IP (Internet Protocol) protocol, and the IS/IS (Intermediate System to Intermediate System) protocol. Routing based on destination addresses specified in the packets is also referred to as “destination based routing” or routing with the aid of destination addresses.

Conventional routing in data networks is a “best effort” routing technique, which is to say that no guarantees are given for the quality of service or, as the case may be, compliance with quality-of-service parameters. The trend with new developments is to extend the routing concept of data packets for transmitting real-time data such as speech, video or audio information, for which purpose compliance with quality-of-service parameters is required. A key approach to improving the transmission quality for data transmission over a data network is the use of multipath routing, i.e. alternative routes to a destination are made available, as a result of which link failures or overload situations can be preempted.

The overhead involved in calculating routing tables increases substantially as the number of possible destinations and more particularly—in the case of multipath routing—possible routes increases.

### SUMMARY OF INVENTION

An object of the invention is to optimize the calculation of routing tables for communication networks composed of nodes and links.

The object is achieved by the subject matter of the independent claims. The invention is based on the idea of performing some of the calculations for setting up routing tables on a server. In the following description a single server is assumed for the sake of simplicity and its calculations are called central calculations, although a network comprising a plurality of servers can also be used in order to improve availability. According to the invention a central calculation of routes between, in each case, a network-internal start and end node is performed. Network-internal, in this context, should be taken to mean that start and end node are nodes of the network, which is to say edge nodes or inner nodes. For traffic that is routed to a destination outside the communication network it makes sense to use one of the edge nodes of the communication network as the end node, from which edge node the traffic is transmitted toward its destination into another network. Information relating to the centrally calculated routes is communicated—by means of a communication protocol, for example—to a node of the network. Said information consists, for example, of the specification of the next hop for the routing to an edge node.

Based on this information the node calculates the entries for a routing table using a routing protocol, the OSPF protocol or the IS/IS protocol, for example. In the process destination addresses of packets to be transported learned via the routing protocol are assigned to the centrally calculated network-internal routes. Said assignment can be carried out on the basis of unique router IDs, for example on the basis of the 32-bit router ID described in the OSPF standard RFC2328. The information transmitted to the router need not necessarily include complete routes. In principle the information relating to the calculated routes can be limited to the information necessary for assigning destination addresses to routes. How extensive the information is in the individual case depends on the routing scheme used. In conventional IP networks, for example, the next hops for the routing to an end node within the network (e.g. an edge node from which an onward routing into another network is initiated) and the respective end node can be specified.

The invention has the advantage that the routes are calculated centrally and so the information relating to the routes can be passed on to a plurality of nodes, for example to all the nodes in the network, so that the corresponding computational overhead arises only once and not for all the nodes using the routes. The invention is particularly advantageous when using multipath routing, because in that case the route calculation is considerably more complex and time-consuming and so more computational overhead can be saved. There is thus no need to distribute information that is used only for route calculation, for example a traffic matrix, to the individual nodes. With multipath routing, moreover, traffic distribution weightings can be determined centrally. Traffic distribution weightings serve for controlling the allocation of the traffic to the alternative routes of the multipath routing scheme and can be used at the router for defining or, as the case may be, calculating routing tables. In spite of the central calculations, with multipath routing each node can respond independently in the event of an error, i.e. redirect traffic from a failed connection to an adjacent node onto the remaining routes of the multipath routing scheme, in other words is not reliant on a rapid response of the central calculations.

The invention also comprises a device for calculating a routing table within a communication network composed of nodes and links, which device comprises a central device (e.g. a server) having means for calculating routes between end nodes of a network, as well as at least one node having means for creating a routing table using a routing protocol. In this arrangement, means for communicating between the central device and the node or nodes are provided, including a communication protocol for example. If the network operates with multipath routing, means for determining traffic distribution weightings can also be provided in the central device as well as means for transmitting the distribution weightings to the nodes.

### BRIEF DESCRIPTION OF THE DRAWING

The subject matter of the invention is explained in more detail below with reference to an exemplary embodiment and with the aid of a figure.

### DETAILED DESCRIPTION OF INVENTION

The figure shows a central device NCS (NCS: stands for Network Control Server) which according to the invention performs some of the calculations for creating routing tables. Also shown are routers or nodes A to G which form part of a network. It is described with reference to the figure how the router D calculates a part of its routing table with the aid of routing information provided by the central device NCS. The routers A, F, G and E represent next hops or, as the case may be, nodes directly connected to the router D. The routers B and C are edge routers of the network via which traffic is relayed to other networks. The dotted connections by means of which said two edge routers B and C are connected to the other routers of the network shown indicate omitted network elements (routers and links) via which traffic can be forwarded to the edge nodes. Table T1 contains information that is transmitted from the central device NCS to the node D. This information is intended for a multipath routing scheme which provides at least two alternative next hops from D for the transmission of traffic to a destination. The central device specifies to the node that 20% of the traffic to be transmitted to the edge node B is to be transmitted via the next hop F and 80% via the next hop G. Traffic to the edge node C is to be transmitted in the proportions: 60% via the next hop E and 40% via the next hop G. Table T2 shows addresses P1 to P3 of networks which can be accessed via the edge router or edge node C. Similarly, table T3 shows the addresses P4 to P6 of networks which can be accessed via the edge router B. The addresses are represented following the usual convention for representing IP addresses, the address and the mask required for interpretation of the address as a network address (after the forward slash) being specified. Using the OSPF protocol, the information relating to the networks that can be accessed via respective edge routers is propagated through the network. In this way the router D learns which networks it can access via the edge routers B and C respectively. In accordance with the information transmitted by the central device it therefore assigns next hops to said network addresses. The resulting routing table FIB (FIB: stands for forwarding information base) is shown in the figure. The network addresses P1 to P3 are assigned the next hops E and G, and the network addresses P4 to P6 the next hops F and G. The table FIB depicted in the figure shows only a very small section from a realistic routing table. Actual routing tables are much more extensive.

By means of the invention only a simple assignment of the network addresses available to the edge routers must be made to next hops specified by the central device or, as the case may be, to specified routes. There is no need for a complete route calculation to take place at each of the nodes.

1-14. (canceled)

15. A method for calculating a routing table for routing data packets within a communication network having an internal start node and an internal end node connected to a destination address and links between the nodes, comprising:
calculating a route between the internal start node and the internal end node;
building a routing table for the routing of packets by assigning destination addresses to the calculated routes;
using a routing protocol for building the routing table;
communicating information relating to the calculated route to a selected node of the network;
storing the communication information in the selected node; and
determining centrally traffic distribution weightings for controlling the allocation of traffic to alternatively available routes.

16. The method as claimed in claim 15, wherein the routing table is build in the selected node, wherein the destination addresses of packets are linked to the calculated routes.

17. The method as claimed in claim 16, wherein the calculation is centralized in the communication network.

18. The method as claimed in claim 17, wherein the communicating information includes an identifier for end nodes and next nodes to be used for routing to said end nodes.

19. The method as claimed in claim 18, wherein the start node or the end node is an edge node.

20. The method as claimed in claim 19, wherein the routing is a multipath routing and a plurality of routes are calculated between the start and end node.

21. The method as claimed in claim 20, wherein the traffic distribution weightings are communicated to the selected node.

22. The method as claimed in claim 21, wherein the routing table is set up based upon the traffic distribution weightings.

23. The method as claimed in claim 20, wherein the number of alternative outgoing links from inner nodes to the end node is two.

24. The method as claimed in claim 20, wherein the number of alternative outgoing links from inner nodes to the end node is greater than two.

25. The method as claimed in claim 20, wherein the selected node is an inner node of the communication network having only an outgoing link to the end node.

26. The method as claimed in claim 25, wherein a connection of the inner node to a further node is defined centrally, wherein the connection is not used in regular operation by the inner node as an alternative link for a multipath routing.

27. The method as claimed in claim 26, wherein the connection is defined centrally for the event of a failure of the outgoing link from the inner node as an outgoing joker link from the inner node for the routing of packets to the end node, wherein the joker link is communicated to the selected node, wherein the routing table is based upon the joker link.

28. The method as claimed in claim 20 wherein the routing protocol is based upon a Open Shortest Path First Protocol.

29. The method as claimed in claim 20 wherein the routing protocol is based upon a Intermediate System to Intermediate System protocol.

30. The method as claimed in claim 20, wherein the method is performed for a plurality of nodes of the communication network.

31. The method as claimed in claim 20, wherein the central calculation is performed by a dedicated device.

32. A device for calculating a routing table for a multipath routing within a communication network composed of nodes and links comprising:
a plurality of network-internal start nodes and a plurality of network-internal end nodes;
a central device for calculating routes between the start nodes and the end nodes;
a selected node to set up a routing table using a routing protocol; and
a communication link between the central device and the selected node by using a communication protocol.

33. The device as claimed in claim 32, wherein the central device determines distribution weightings.

34. The device as claimed in one of claims 33, wherein routes are communicated from the central device to the selected node based upon the communication protocol.

35. The device as claimed in one of claims 34, wherein distribution weightings are communicated from the central device to the selected node based upon the communication protocol.
